(19) United States
(12) Patent Application Publication
(10) Pub. No.: US 2014/0022945 A1
(43) Pub. Date: Jan. 23, 2014

(54) METHOD FOR OBTAINING INFORMATION ABOUT THE OPERATING STATES OF NODES OF A COMMUNICATIONS NETWORK IN VIEW OF OPTIMIZED-ENERGY-COST ROUTING, AND CORRESPONDING DEVICE

(71) Applicants: Dominique Verchere, Nozay (FR); Annalisa Morea, Nozay (FR); Nicolas Le Sauze, Nozay (FR)

(72) Inventors: Dominique Verchere, Nozay (FR); Annalisa Morea, Nozay (FR); Nicolas Le Sauze, Nozay (FR)

(73) Assignee: ALCATEL-LUCENT, Paris (FR)

(21) Appl. No.: 14/004,810

(22) PCT Filed: Feb. 24, 2012
(86) PCT No.: PCT/EP2012/053192

§ 371 Date: Oct. 4, 2013

(30) Foreign Application Priority Data
Apr. 5, 2011 (FR) 1152917

(51) Int. Cl. H04L 12/12

(52) U.S. Cl. CPC H04L 12/12
USPC 370/254

(57) ABSTRACT

The method is dedicated to managing information related to the operated states of a group of nodes of a communications network, connected to one another by oriented links each associated with a maximum transmission capacity controlled by elements of the nodes that may be placed into a state from among P operating states, chosen from among an up state and a down state and/or at least one intermediate idle state. This method includes (i) obtaining, for each oriented link of each node, P values Vjj′i, where i=1 to P, respectively representative of the distribution percentages of its maximum transmission capacity between elements placed into P different operating states, and (ii) building with these obtained values Vjj′i an operating state table of the nodes of the group, which for each of the links is representative of its available, unavailable, and, if any, partially available transmission capacities.

### TECHNICAL FIELD

The invention pertains to communications networks that comprise at least one group of nodes connected to one another by oriented links, and more specifically the optimization of the use of such nodes, particularly in to terms of energy consumption.

Here, the term “oriented link” refers to a link, whether wired or wireless, capable of enabling the transmission of signals from a first node to a second node, and therefore in a chosen direction. Consequently, here the term “link” refers to a transmission, whether wired or wireless, capable of enabling the transmission of signals between two nodes, independent of the direction.

It should be noted that the invention relates to any type of communications network, including optical networks.

### STATE OF THE ART

As is known to a person skilled in the art, certain communications networks, called “dynamic”, comprise nodes, generally called routers or switches, which are equipped with elements, such as line-cards, optical interfaces equipped with lasers, optical cross-connects (or OXCs), or electronic interfaces, which consume energy when they are placed in a state called “active” (or “up”) or in a state called “partially active” (or “idle”).

Here, the term “up state” refers to a state in which all the components of an element are ready to be used and therefore consume energy, and “idle state” refers to an intermediate state in which certain components of an element consume energy in order to be ready for immediate use, as it takes a relatively long time to switch them from the so-called off (or inactive or “down”) state to the active (or up) state, while some others are placed in the off (or down) state, and therefore consume no energy, as it takes a very short length of time to switch them from the off (or down) state to the active (or up) state.

Thanks to this type of multiple-operation element, it is possible to manage the energy consumption of a part of a (communications) network based on the needs of the moment. This management is generally provided by a network management system (or NMS). It should be understood that there is no need to temporarily feed some elements of a node in whole or in part, which are dedicated to an inter-node link if that link's maximum transmission capacity available is only partially used, or not at all used, temporarily.

### SUMMARY OF THE INVENTION

Unfortunately, no routing protocol provides for the compilation of elements that have been placed by the network management system into an off (or down) state, or a partially on (or idle) state, which harms the routing within networks which are called “energy-efficient” and more precisely, the calculation of the routing paths, because all the elements of active nodes are then considered to be placed in their active (or on, or up) state. Additionally, this prohibits any actually dynamic adaptation of the nodes as a function of transmission capacity allocation demands.

The purpose of the invention is therefore to improve the situation.

According to a first aspect, the invention proposes a method, dedicated to the management of information related to the first operating state of a group of nodes of a communications network, linked to one another by oriented links Ljj′ each associated with a maximum transmission capacity controlled by elements of nodes that may be placed in a state from among P operating states (where P≧2), chosen from among an active state and an off state and/or at least one intermediate idle state, and comprising the following steps:
(i) obtaining, for each oriented link Ljj′ of each node, P values Vjj′i, where i=1 to P, respectively representative of distribution percentages of its maximum transmission capacity between elements placed in the P different operating states, and
(ii) building with the obtained values Vjj′i an operating state table of the group's nodes, which is representative, for each of the links Ljj′, of its available, unavailable, and, if they exist, partially available transmission capacity(ies).

The method may comprise other characteristics that may be taken separately or in combination, and in particular:
in step (ii) P graphs may be constructed, each representative of the oriented links Ljj′ between the nodes and values Vjj′i associated with one of the P operating states;
the nodes may provide the values Vjj′i, during step (i), spontaneously or upon request, by way of messages;
   the messages may comply with a chosen link state routing protocol;
      the link state routing protocol may, for example, be Open Shortest Path First-Traffic Engineering (OSPF-TE);
         the values Vjj′i may be integrated into dedicated Type-Length-Value (or TLV) fields of type Link State Advertisement (or LSA) messages;
in the event that a request is received to allocate a transmission capacity for a communication that is to pass through an input node of the group and an output node of that same group, a step (iii) may additionally be provided in which it is determined, based on the operating state table and on traffic engineering information related to the actual use of the available transmission capacities of the oriented links Ljj′, at least one inter-node path that travels via oriented links Ljj′ established between the input and output nodes;
   in step (iii), every time an inter-node link has an available and usable transmission capacity that is less than the transmission capacity defined within the received allocation request, it may be determined whether some of the partially available transmission capacity of that same inter-node link may be used as a complement of that available and usable transmission capacity to fulfill that received allocation request, and if so, that inter-node link may be retained, whereas if not, that inter-node link might not be retained;
   In one variant, in step (iii), every time an inter-node link has an available and usable transmission capacity that is less than the transmission capacity defined within the received allocation request, it may be determined whether some of the partially available transmission capacity may be used as a complement of that available and usable transmission capacity to meet that received application request, and if so, that inter-node link may be retained, whereas if not, it may be determined whether some of the unavailable transmission capacity of the same inter-node link may be used as a complement of its available and usable transmission capacity to meet at that received allocation request, and if so that inter-node link may be retained, whereas if not, that inter-node link might not be retained;
   in step (iii), in the event that it is determined that there is part of the partially available transmission capacity and/or part of the unavailable transmission capacity of an oriented link necessary to complement the available and usable transmission capacity of that oriented link to meet the received allocation request, a message may be addressed to at least one of the two nodes concerned by that link, requesting the placement into an up state of at least one designated element, associated with that oriented link and until that point placed in a partially up or down state;
   each inter-node path may be determined in step (iii) based on at least one chosen criterion;
      each criterion may, for example, be chosen from among (at least) one criteria related to the path's number of oriented links Ljj′, an energy cost criterion, a location criterion, and a load distribution criterion;
         at least one of the criteria may be adjustable based on the oriented links' load rate.

According to a second aspect, the invention proposes a device, whether centralized or distributed, that first, is dedicated to the management of information related to the operating state of a group of nodes of a communications network, connected to one another by oriented links Ljj′ each associated with a maximum transmission capacity controlled by elements of nodes that may be placed into a state from among P operating states (where P≧2), chosen from among an on state and an off state and/or at least one intermediate idle state, and second, is capable of implementing a method of the type presented above.

According to a third aspect, the invention proposes a network equipment that firstly is capable of forming part of a communications network and of being connected to other nodes of that network by associated oriented links Ljj′ each associated with a maximum transmission capacity controlled by elements of nodes that may be placed in a state from among P operating states (where P≧2), chosen from among an up state and a down state and/or at least one intermediate idle state, and additionally comprising an information management device of the type presented above.

### BRIEF DESCRIPTION OF THE DRAWINGS

Other characteristics and advantages of the invention shall become apparent upon examining the detailed description below, and the attached drawings, in which:

FIG. 1 very schematically and functionally depicts a communications network comprising seven nodes, connected to one another by links, and a device according to the invention, here of the centralized type,

FIG. 2 very schematically depicts a first graph that shows only the available transmission capacities (used and usable) on the oriented links of the communications network of FIG. 1,

FIG. 3 very schematically depicts a second graph showing only the partially available transmission capacities on the oriented links of the communications network on the oriented links of the communications network of FIG. 1,

FIG. 4 very schematically depicts a third graph showing only the unavailable transmission capacities on the oriented links of the communications network on the oriented links of the communications network of FIG. 1,

FIG. 5 very schematically depicts a fourth graph showing the available and partially available (in terms of wavelength) transmission capacities on oriented links of the communications network of FIG. 1, which might participate in routing paths running from an input node N1 to an output node N6,

FIG. 6 very schematically depicts a fifth graph showing the available and partially available (in terms of wavelength) transmission capacities, after a state change request, on three oriented links of the communications network of FIG. 1 participating in a selected first routing path, running from the input node N1 to the output node N6,

FIG. 7 very schematically depicts a sixth graph showing the available and partially available transmission (in terms of wavelength) capacities on four oriented links of the communications network of FIG. 1 participating in a selected second routing path, running from the input node N1 to the output node N6.

The appended drawings might not merely serve to complete the invention, they might contribute to the definition of the invention, if necessary.

### DETAILED DESCRIPTION

It is a particular object of the invention to make it possible to compile, with a routing protocol, operating states of the node elements (Nj) belonging to a communications network (RC) of the type known as “energy-efficient”, particularly for the purpose of optimizing the routing of the communications.

It is assumed hereinafter, by way of an example, that the communications network (RC) is an optical network. However, the invention is not limited to this sort of communications terminal. It pertains to any communications network comprising at least one group of nodes comprising elements that need energy to function and that may selectively and dynamically be placed in one state from among P operating states (where P≧2), chosen from among an on (or up) state and an off (or down) state and/or at least one partially on (or idle) state. It shall therefore be understood that the elements may feature either an up state and a down state, or an upstate and at least one idle state, or an up state, a down state, and at least one idle state.

Consequently, the invention particularly pertains to optical networks, particularly WSON (“Wavelength Switched Optical Network”), IP/MPLS (“Internet Protocol/MultiProtocol Label Switching”) Internet protocol and control plane networks, and Carrier Grade Ethernet Networks, and all other types of data transport networks.

Furthermore, it is assumed hereinafter, by way of an illustrative example, that the node elements can only assume three different operating states (i.e. the up state, the down state, and a single idle state). Consequently, the number P is equal to 3. However, this number P may be equal to 2 (particularly when there is no idle state) or greater than 3.

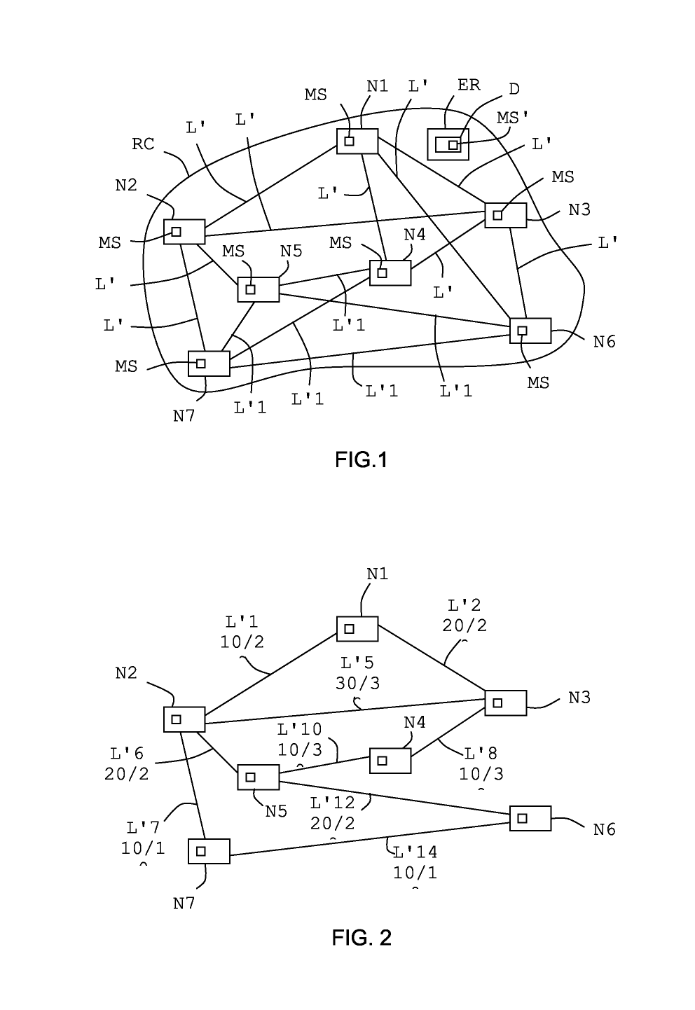

FIG. 1 schematically depicts a (communications) network RC comprising a group of nodes Nj connected to one another by links L′k, and additionally, an information-obtaining device D according to the invention, here of the centralized type, but which may also be distributed, as we shall see later on.

It is important to note that a link L′k established between two nodes Nj and Nj′ (j′≠j) comprises a first oriented link Ljj′ running from the node Nj to the node Nj′ and/or a second oriented link Lj′j running from the node Nj′ to the node Nj.

It should also be noted that in the example depicted in FIG. 1, the group comprises seven nodes N1 to N7 (j=1 to 7). However, it may comprise more or less than seven nodes; what is important is that it comprises at least one. It should also be noted that a group of nodes Nj may potentially constitute what the person skilled in the art calls a routing area or an autonomous system.

It should also be noted that in the example depicted in FIG. 1, the nodes are connected to one another by 14 links L′1 to L′14 (k=1 to 14). However, they may be connected to one another by a greater or lesser number of links.

For example, the nodes Nj are routers or cross-connects.

It should also be noted that each node Nj comprises elements of the aforementioned type, associated with oriented links Ljj′ or Lj′j. In fact, each oriented link Ljj′ leaving a node Nj is coupled to one or more elements of that node Nj which are dedicated to it, and each oriented link Lj′j arriving at a node Nj is coupled to one or more elements of that node Nj.

For example, the elements are line-cards, optical interfaces equipped with lasers, optical cross-connects (or OXCs), or electronic interfaces.

It should also be noted that each oriented link Ljj′ has a predefined maximum transmission capacity CTMjj′. Generally, the two oriented links Ljj′ and Lj′j of the same link L′k have the same predefined maximum transmission capacity. However, the invention also applies to cases in which the two oriented links Ljj′ and Lj′j of a single link L′k respectively have different predefined maximum transmission capacities.

The invention proposes implementing within at least one group of nodes Nj of a network RC a method devoted to managing information related to the operating state of these nodes Nj.

This method comprises at least the two main steps (i) and (ii).

A first step (i) consists of obtaining, for each oriented link Ljj′ of each node Nj, P values Vjj′i, where i=1 to P, respectively representative of the distribution percentages of its maximum transmission capacity CTMjj′ between elements placed within these P different operating states.

For example, when P=3, i.e. whenever there is one defined idle state, for each oriented link Ljj′ the following are obtained:
a first value Vjj′1 associated with the up state and representative of the ratio between its transmission capacity that is available CTDjj′ and its maximum transmission capacity CTMjj′ (for example, CTDjj′/CTMjj′),
a second value Vjj′2 associated with the idle state and representative of the ratio between its transmission capacity that is partially available CTPjj′ and its maximum transmission capacity CTMjj′ (for example CTPjj′/CTMjj′), and
a third value Vjj′3 associated with the up state and representative of the ratio between its transmission capacity which is unavailable CTIjj′ and its maximum transmission capacity CTMjj′ (for example, CTIjj′/CTMjj′),

A transmission capacity of an oriented link Ljj′ is said to be available when the elements of the node Nj that are associated with that oriented link Ljj′ are all placed in an up (or active) state. It is important to note that the available transmission capacity CTDjj′ of an oriented link Ljj′ is divided into two complementary parts: an available, used transmission capacity CTDAjj′ and an available, usable transmission capacity CTDBjj′ (where CTDjj′=CTDAjj′+CTDBjj′). This is because the available transmission capacity CTDjj′ of an oriented link Ljj′ is not necessarily all used at a given moment.

A transmission capacity of an oriented link Ljj′ is said to be partially available when the elements of the node Nj that are associated with that oriented link Ljj′ are partially placed in the up state (some are up and some are down).

A transmission capacity of an oriented link Ljj′ is said to be available when the elements of the node Nj that are associated with that oriented link Ljj′ are all placed in the down (or off) state.

Preferentially, these are the nodes Nj of a group that provide, during the first step (i) the values Vjj′i which concern them by means of messages. This providing may occur periodically, or upon a request, or whenever the state of one of the elements of a node Nj is modified.

It should be noted that the messages containing the values Vjj′ may be transmitted by each node Nj to the neighboring nodes Nj′ (j′≠j) to which it is connected by a link L′k, and/or to an inventive device D tasked with managing information that relate to the operating state of the nodes Nj of at least the group to which it belongs. It is important to note that the device D may work either in a centralized way for all the nodes of at least one group of a network RC, in which case it forms part of a network device ER as depicted in a non-exhaustive fashion in FIG. 1, or in a distributed fashion for a single node Nj of a group of a network RC, in which case it forms part of that node.

By way of a non-exhaustive example, the messages may comply with a chosen link state routing protocol. For example, certain messages of the OSPF-TE (“Open Shortest Path First-Traffic Engineering”) protocol, which is well known to the person skilled in the art and is used to exchange information about traffic engineering, may be used. In this case, the P values Vjj′i of each node Nj may, for example, be integrated into P dedicated Type-Length-Value (or TLV), fields, potentially type 6, of Link State Advertisement (or LSA) messages of the OSPF-TE v.2 protocol.

Purely as an illustrative example, a new TLV subfield (or “sub-TLV”), for example called “Idle Bandwidth”, may define the idle capacity. This subfield may be type x, where x is a value four bytes long that had not yet been allocated by the IANA (“Internet Assigned Numbers Authority”).

Likewise, a new TLV subfield (or “sub-TLV”), for example called “Down Bandwidth”, may define the down capacity. This sub-field may be type y, where y is a value four bytes long that has not yet been allocated by the IANA.

The active capacity may be defined by the TLV subfield (or “sub-TLV”) called “Up Bandwidth”, which is an extension of the maximum capacity (or “Maximal Bandwidth”) defined by the RFC3630 rule of the IETF.

However, other messages of other routing protocols may be used to transmit the value Vjj′, and particularly certain messages of the standard IS-IS-TE protocol (for “Intermediate System-Intermediate System-Traffic Engineering) or any proprietary routing protocol that makes it possible to transport operating state information of the network equipment.

A second step (ii) of the inventive method consists of building with the obtained values Vjj′i an operating state table of the group's nodes Nj, which is representative for each of the oriented links Ljj′ of its available CTDjj′ and unavailable CTIjj′ transmission capacities, and, if they exist, partially available transmission capacities CTPjj′.

This device D is the one that is tasked with constituting this operating state table. It should be noted that the device D preferentially updates this table periodically, and not necessarily each time that it receives new value Vjj′. The update period is a configuration parameter of the routing protocol, which transports the operating state information.

In this case, this operating state table is stored by the device D in storage means MS′ and provided to all the nodes Nj of the group so that it can store them in the storage means MS. It should be noted that whenever a node Nj is connected to nodes belonging to multiple different groups, it is preferable for it to store within its storage means MS the different operating state tables of these different groups. It should also be noted that an operating state table may potentially be stored in a distributed fashion in multiple nodes Nj.

The storage means MS and MS′ may come in any form known to the person skilled in the art, and particularly in the form of a memory or database, potentially a software- or file-based one.

It should be noted that an operating state table may be constructed in a manner similar to that of a link state table, which is well-known to the person skilled in the art. In this case, the operating state table is accessible via a routing protocol engine, such as the same one, though adapted, as the one used for the OSPF-TE protocol.

It should also be noted that during the second step (ii), based on the table of operating states, at least P graphs G1 may also be constructed that are each representative of oriented links Ljj′ between the nodes Nj of a group and values Vjj′i associated with one of the P operating states. These graphs G1 shall particularly be useful during the phase of determining the routing path, which shall be discussed later on.

For example, when P=3, the following graphs may be drawn for a group of nodes Nj:
a first graph G1 showing the available transmission capacities CTDjj′ on the oriented links Ljj′ between the nodes Nj,
   a second graph G
   a third graph

FIG. 2 schematically depicts a non-exhaustive example of the first graph G1. It is assumed in this example that all the links L′Ic are formed of two oriented links Ljj′ and Lj′j that exhibit the same maximum transmission capacity CTMjj′=CTMj′j, which is equal to 40 Gbps. In FIG. 2, the link references L′k are accompanied by an “X/Y” expression in which X designates the available transmission capacity CTDjj′ on the oriented link Ljj′ of the link L′k, and Y designates the available transmission capacity CTDj′j on the oriented link Lj′j of the link L′k. For example, the expression 10/20 placed under the reference of the link L′1 indicates that the available transmission capacity CTD12 on the oriented link L12 is equal to 10 Gbps (out of 40 Gbps of CTM12) and the available transmission capacity CTD21 on the oriented link L21 is equal to 20 Gbps (out of 40 Gbps of CTM21). Likewise, the expression 20/20 placed under the reference of the link L′12 indicates that the available transmission capacity CTD56 on the oriented link L56 is equal to 20 Gbps (out of 40 Gbps of CTM56) and the available transmission capacity CTD65 on the oriented link L65 is equal to 20 Gbps (out of 40 Gbps of CTM65).

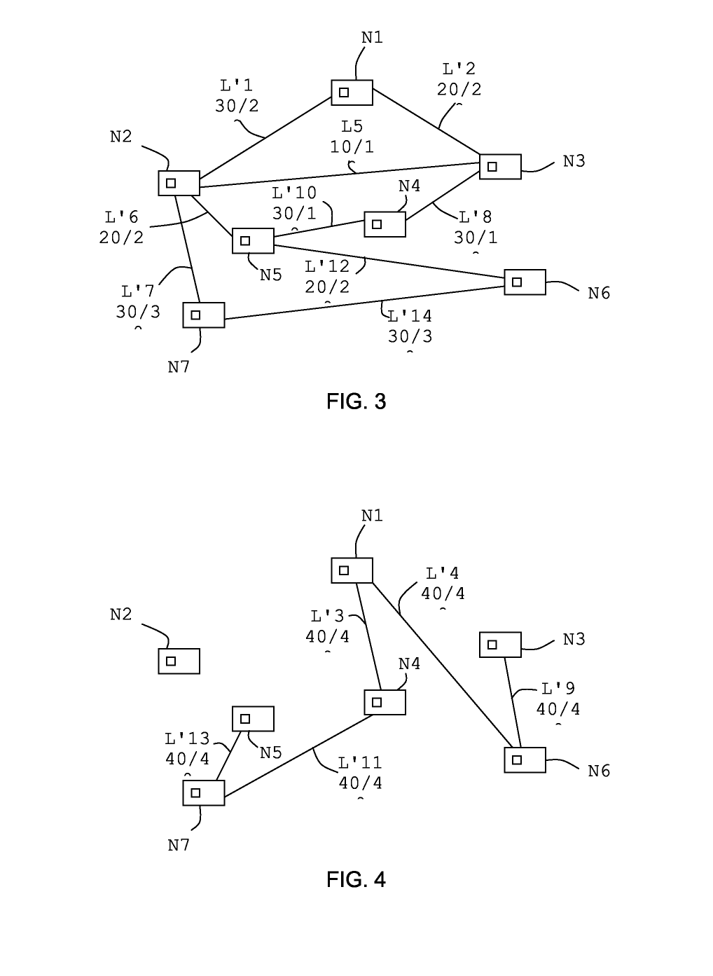

FIG. 3 schematically depicts a non-exhaustive example of the second graph G2, which reproduces the same conditions as those in the example of FIG. 2. In FIG. 3, the link references L′k are accompanied by an “X/Y” expression in which X designates the partially available transmission capacity CTPjj′ on the oriented link Ljj′ of the link L′Ic, and Y designates the partially available transmission capacity CTPj′j on the oriented link Lj′j of the to link L′k. For example, the expression 30/20 placed under the reference of the link L′1 indicates that the partially available transmission capacity CTP12 on the oriented link L12 is equal to 30 Gbps (out of 40 Gbps of CTM12) and the partially available transmission capacity CTP21 on the oriented link L21 is equal to 20 Gbps (out of 40 Gbps of CTM21). Likewise, the expression 20/20 placed under the reference of the link L′12 indicates that the partially available transmission capacity CTP56 on the oriented link L56 is equal to 20 Gbps (out of 40 Gbps of CTM56) and the partially available transmission capacity CTP65 on the oriented link L65 is equal to 20 Gbps (out of 40 Gbps of CTM65).

FIG. 4 schematically depicts a non-exhaustive example of the third graph G3, which reproduces the same conditions as those of the examples of FIGS. 2 and 3. In FIG. 4, the link references L′Ic are accompanied by an “X/Y” expression in which X designates the unavailable transmission capacity CTIjj′ on the oriented link Ljj′ of the link L′k, and Y designates the unavailable transmission capacity CTIj′j on the oriented link Lj′j of the link L′k. For example, the expression 40/40 placed under the reference of the link L′3 indicates that the unavailable transmission capacity CTI14 on the oriented link L14 is equal to 40 Gbps (out of 40 Gbps of CTM14) and the unavailable transmission capacity CTI41 on the oriented link L41 is equal to 40 Gbps (out of 40 Gbps of CTM41). Likewise, the expression 40/40 placed under the reference of the link L′13 indicates that the unavailable transmission capacity CTI57 on the oriented link L57 is equal to 40 Gbps (out of 40 Gbps of CTM57) and the unavailable transmission capacity CTI75 on the oriented link L75 is equal to 40 Gbps (out of 40 Gbps of CTM75).

The inventive method may also and advantageously comprise a third step (iii) that is performed by the device D whenever it receives a request to allocate a transmission capacity CTR for a communication that must go through an input node Nj of the group and an output node Nj′ of that same group.

Whenever the aforementioned situation occurs, at least one inter-node routing path Cn that takes oriented links Ljj′ established between the input Nj and output Nj′ nodes is determined (for example, by the device D) based on the operating state table (stored within its storage means (MS′) and to on auxiliary information that relates to the actual (current) use of the available transmission capacities CTDjj′ of the oriented links Ljj′.

It should be noted that when the device D is implemented within a node Nj, it determines inter-node routing paths Cn for its own node Nj, and it may also, potentially, determine inter-node routing paths Cn′ for other nodes that request this from it.

The auxiliary information particularly comprises the available, used transmission capacity CTDAjj′ of an oriented link Ljj′ and/or the available, usable transmission capacity CTDBjj′ of that same oriented link Ljj′ (where CTDjj′=CTDAjj′+CTDBjj′). The information CTDjj′ comes, for example, from configuration information of the network infrastructure and traffic engineering information CTDAjj′ regarding the usage of the network.

In step (iii), every time that an oriented link Ljj′ has an available, usable transmission capacity CTDjj′ which is less than the transmission capacity CTR defined within a received allocation request, it may be determined whether part of the partially available transmission capacity CTPjj′ of that same link Ljj′ can be used as a complement of the available, usable transmission capacity CTDBjj′ to meet that received allocation request. If it can, that oriented link Ljj′ may be retained, whereas if it can't, that oriented link Ljj′ might not be retained.

In other words, if CTR<CTDBjj′ or CTR<CTDBjj′+CTPjj′, then the oriented link Ljj′ is retained for computing the routing paths Cn, and if CTR>CTDBjj′+CTPjj′, then the oriented link Ljj′ is not retained for computing the routing paths.

In one variant embodiment, in step (iii), every time that an oriented link Ljj′ has an available, usable transmission capacity CTDBjj′ which is less than the transmission capacity CTR defined within a received allocation request, it may be determined whether part of the partially available transmission capacity CTPjj′ of that same link Ljj′ can be used as a complement of the available, usable transmission capacity CTDBjj′ to fulfill that received allocation request. If it can, that oriented link Ljj′ may be retained, while if it can't, it may be determined whether part of the unavailable transmission capacity CTIjj′ of that same inter-node link may be used as a to complement to the available, usable transmission capacity CTDBjj′ to fulfill that received allocation request. Then, if it can, that oriented link Ljj′ may be retained, whereas if it can't, that oriented link Ljj′ might not be retained.

In other words, if CTR<CTDBjj′, or CTR<CTDBjj′+CTPjj′, or CTR<CTDBjj′+CTPjj′+CTIjj′, or CTR<CTDBjj′+CTIjj′, then the oriented link Ljj′ for computing the routing paths Cn, and if CTR>CTDBjj′+CTPjj′+CTIjj′, then the oriented link Ljj′ is not retained for computing the routing paths.

Once the oriented links Ljj′ that might participate in routing paths have been determined, at least one routing path Cn is computed. Preferentially, multiple routing paths Cn are computed, for example two or three, then one of them is selected based on at least one chosen criterion.

Any criterion known to the person skilled in the art that may serve to select a routing path from among more than one may be used here. Here, one may, for example, use a criterion that relates to the number of inter-node oriented links Ljj′ in the path, in which case preference is given to the shortest one (i.e. the one that has the fewest oriented links Ljj′), and/or an energy cost criterion, in which case preference is given to the routing path that consumes the least energy, and/or a location criterion, in which case preference is given to oriented links Ljj′ that pass through nodes situated in chosen locations, and/or a load balancing criterion, in which case preference is given to oriented links Ljj′ whose load rate is below a threshold. Other criteria and/or a combination of multiple criteria may also be used, including those mentioned above.

It should be noted that at least one of the criteria used during the path selection Cn may be adjustable as a function, for example, of the load rate of the oriented links Ljj′. In other words, weights may be assigned to each of the criteria used, and its weights may be varied based on the load rate of the oriented links Ljj′. This way, each network operator may set its own criteria with its own weights depending on its own network infrastructure configuration strategies.

If the selected routing path Cn requires an operating state change in one or more elements of one or more nodes, these nodes must be alerted in order for them to reconfigure. As a reminder, this situation occurs every time it has been determined that some of the partially available transmission capacity CTPjj′ and/or some of the unavailable transmission capacity CTIjj′ of at least one oriented link Ljj′ was/were necessary to complement the available, usable transmission capacity CTDBjj′ of that same oriented link Ljj′ to fulfill a received allocation request. In this case, during the third step (iii) a message is addressed to at least one of the two nodes Nj and Nj′ that are concerned by that oriented link Ljj′, ordering it to put at least one designated element associated with that oriented link Ljj′ into an up state, which had until then been placed in an idle or down state. This way, each oriented link Ljj′ of the selected routing path Cn will be able to fulfill the received allocation request.

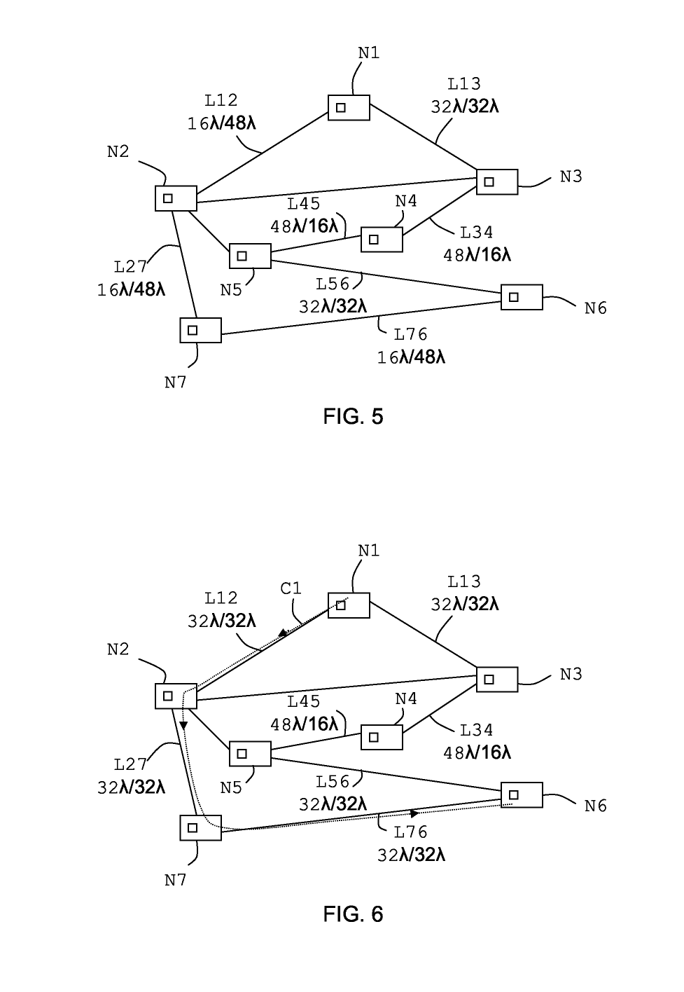

FIG. 5 schematically depicts a graph showing the available transmission capacities CTDjj′ and partially available capacities CTPjj′ on each of the oriented links Ljj′ (of the group of nodes Nj of the network RC of FIG. 1) which are capable of participating in two routing paths C1 and C2 running from the input node N1 to the output node N6. In FIG. 5, the oriented link Ljj′ references are accompanied by an “X/Y” expression wherein X designates the available transmission capacity CTDjj′ (expressed as a number of wavelengths λ) on the oriented link Ljj′ and Y designates the partially available transmission capacity CTPjj′ on that same oriented link Ljj′ (expressed as a number of wavelengths λ). For example, the expression 16λ/48λ placed under the reference of the oriented link L12 indicates that the available transmission capacity CTD12 on the oriented link L12 is equal to 16λ (i.e. 10 Gbps if it is assumed that 1λ corresponds to 625 kbps) and the partially available transmission capacity CTP12 on the oriented link L12 is equal to 48λ (or 30 Gbps if it is assumed that 1λ corresponds to 625 kbps). Likewise, the expression 32λ/32λ placed under the reference of the link L56 indicates that the available transmission capacity CTD56 on the oriented link L56 is equal to 32λ (i.e. 20 Gbps if it is assumed that 1λ corresponds to 625 kbps) and the partially available transmission capacity CTP56 on the oriented link L56 is equal to 32λ (or 20 Gbps if it is assumed that 1λ corresponds to 625 kbps).

FIG. 6 schematically depicts a graph showing the available CTDjj′ and partially available CTPjj′ transmission capacities on each of the oriented links Ljj′ (of the group of nodes Nj of the network RC of FIG. 1) that participate in a first routing path C1 running from the input node N1 to the output node N6, via the nodes N2 et N7, after changing the states of chosen elements within the nodes N1, N2 and N7 intended to fulfill an allocation request requiring a transmission capacity CTR equal to 5λ in the presence of initial available, used transmission capacities CTDAjj′ equal to 14λ on each of the oriented links Ljj′ and therefore available, usable transmission capacities CTDBjj′ equal to 2λ (16λ−14λ=2λ) on each of the oriented links Ljj′. In this example, it is also assumed that a line-card element, associated with an oriented link Ljj′ and constituting the smallest granularity, has 16 wavelengths (or 16λ), and therefore that to increase the available, usable transmission capacity CTDBjj′ of an oriented link Ljj′, the node in question Nj is asked to switch one of the line cards associated with that oriented link Ljj′ from the idle state to the up state.

In FIG. 6, the oriented link Ljj′ references are accompanied by an “X/Y” expression wherein X designates the available transmission capacity CTDjj′ (expressed as a number of wavelengths λ) on the oriented link Ljj′ and Y designates the partially available transmission capacity CTPjj′ on that same oriented link Ljj′ (expressed as a number of wavelengths λ) after the state change. For example, the expression 32λ/32λ placed under the reference of the link L12 indicates that the available transmission capacity CTD12 on the oriented link L12 has become equal to 32λ instead of 16λ before the state change (i.e. 20 Gbps if it is assumed that 1λ corresponds to 625 kbps) and the partially available transmission capacity CTP12 on the oriented link L12 has become equal to 32λ instead of 48λ before the state change (i.e. 20 Gbps if it is assumed that 1λ corresponds to 625 kbps).

It is assumed that the first path C1 is now capable of largely fulfilling the allocation request requiring a transmission capacity CTR equal to 5λ. This is because we have gone from an initial situation in which each oriented link Ljj′ of the first path C1 has CTDAjj′=14λ available and used and CTDBjj′=2λ available and usable, to an intermediate situation in which each oriented link Ljj′ of the first path C1 has 14λ available and used and 18λ available and usable after the state change, and then from the aforementioned intermediate situation to a final situation in which each oriented link Ljj′ of the first path C1 to has 19λ available and used and 13λ available and usable after the required 5λ have been allocated.

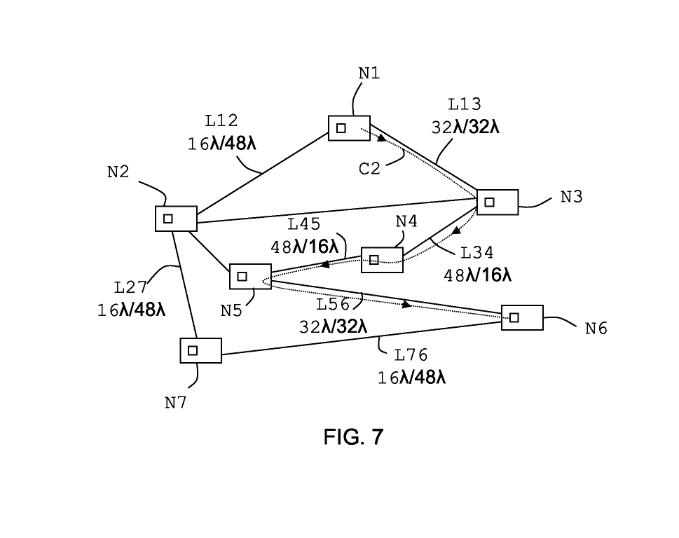

FIG. 7 schematically depicts a graph showing the available CTDjj′ and partially available CTPjj′ transmission capacities on each of the oriented links Ljj′ (of the group of nodes Nj of the network RC of FIG. 1) that participate in a second routing path C2 running from the input node N1 to the output node N6, via the nodes N3, N4 and N5, without a necessary state change of the elements of these nodes, and intended to fulfill the same allocation request as the previous one (i.e. a transmission capacity CTR equal to 5λ in the presence of initial available and used transmission capacities CTDAjj′ equal to 25λ out of 32λ for L13, 34λ out of 48λ for L34, 43λ out of 48λ for L45, and 30λ out of 36λ for L56. Consequently, it is not necessary to carry out state changes to establish the connection C2 requiring a transmission capacity CTR equal to 5λ.

In FIG. 7, the oriented link Ljj′ references are accompanied by an “X/Y” expression wherein X designates the available transmission capacity CTDjj′ (expressed as a number of wavelengths λ) on the oriented link Ljj′ and Y designates the partially available transmission capacity CTPjj′ on that same oriented link Ljj′ (expressed as a number of wavelengths λ). For example, the expression 32λ/32λ placed under the reference of the link L13 indicates that the available transmission capacity CTD13 on the oriented link L13 has remained equal to 32λ (i.e. 20 Gbps if it is assumed that 1λ corresponds to 625 kbps) and the partially available transmission capacity CTP13 on the oriented link L13 has remained equal to 32λ.

It should be understood that the second path C2 is capable of exactly fulfilling the allocation request requiring a transmission capacity CTR equal to 5λ, with no state change and after the required 5λ has been allocated. We have therefore gone from an initial situation in which the oriented link L13 of the second path C2 has 25λ available and used and 7λ available and usable, the oriented link L34 of the second path C2 has 34λ available and used and 14λ available and usable, the oriented link L45 of the second path C2 has 43λ available and used and 5λ available and usable, and the oriented link L56 of the second path C2 has 30λ available and used and 6λ available and usable, to a final situation in which the oriented link L13 of the second path C2 has 30λ available and used and 2λ available and usable, the oriented link L34 of the second path C2 has 39λ available and used and 9λ available and usable, the oriented link L45 of the second path C2 has 48λ available and used and 0λ available and usable, and the oriented link L56 of the second path C2 has 35λ available and used and 1λ available and usable, after the required 5λ has been allocated.

It should be understood that the first path C1 shall be selected when the criteria with the greatest weights are load-balancing and available and usable transmission capacity on each oriented link Ljj′, while the second path C2 shall be selected when the criteria with the greatest weight is energy cost (establishing the path C2 does not actually require any additional energy).

One illustrative and therefore non-exhaustive example of a path-computing algorithm is given in the appendix.

It should be noted that it may also be beneficial to have a transmission capacity allocation for a routing path in order to switch elements, which are temporarily not serving, from an active or partially active state to a passive state, in order to temporarily save energy.

It shall also be noted that the device D is preferentially constructed in the form of software (or computer) modules. However, it may also be constructed in the form of a combination of electronic circuits and software (or computer) modules.

The invention offers several advantages, which include:
it makes it possible to offer genuine suitability among the operating states of the necessary equipment within a communications network, depending on the traffic to be transported,
it makes it possible to optimize routing when that routing incorporates energy consumption criteria,
it makes it possible to efficiently adjust the energy consumption of the network nodes' elements.

The invention is not limited to the embodiments of the information management device, network equipment, and information management method described above, which are only given as examples; rather, it encompasses all variants that a person skilled in the art may envision within the scope of the claims below.

### APPENDIX

An example path-computing algorithm that makes it possible to preserve the consumed energy is given below. In this example, the variable “X” represents the length of a path Cn′ from a start node (router A) to its neighbor, node R, if that path Cn′ is to pass through a node R′. If that path Cn′ is shorter than the selected and saved current path Cn in reaching the node R, the current path Cn is replaced by that path Cn′ (associated with X). Furthermore, the variable “dist_entre (R′, R)” represents the length between to the two neighboring nodes R′ and R with the weighted graph links according to three operating states: active (or UP) partially active (or IDLE), and off (or DOWN).

function PS_computer (PS_graph, source_node):

| | |
|---|---|
| for each node R in PS_graph: | // Initializations |

| | |
|---|---|
| dist[R] := infinity ; | // Unknown distance function from |

source_node to v

previous[R] := undefined ; // Previous node in optimal

path from source_node

| end for ; | |
|---|---|
| dist[source_node] := 0 ; | // Distance from source_node to |

source_node is null

| L := the set of all nodes in PS_graph ; | |
|---|---|
| // All nodes in the PS_graph are not optimal - thus are in the set L | |
| while L is not empty: | // The loop of the |

PS_computer(.,.)

R′ := node in L with smallest dist[ ] ;
if dist[R′] = infinity:

| | |
|---|---|
| break ; | // all remaining vertices are inaccessible |

from source_node

end if ;
remove R′ from L ;
for each neighbor R of R′: // where R has not yet been

removed from L.

| X := dist[R′] + dist_between(R′, R) ; | |
|---|---|
| if X < dist[R]: | // Relax (R′,R,a) |

dist[R] := X ;
previous[R] := R′ ;

end if ;

end for ;

end while ;
return dist[ ] ;

end PS_computer.

1. A method for managing information related to the operating state of a group of nodes of a communications network, connected to one another by oriented links each associated with a maximum transmission capacity controlled by elements of said nodes that may be placed in one state from among P operating states, chosen from among an up state and a down state and/or at least one intermediate idle state, said method comprising the following steps: (i) obtaining, for each oriented link of each node, P values Vjj′i, where i=1 to P, respectively representative of the distribution percentages of its maximum transmission capacity between elements placed within said P different operating states, and (ii) building with said obtained values Vjj′i an operating state table of said nodes of the group, representative for each of said oriented links of its available, unavailable, and, if any partially available transmission capacities.

2. A method according to claim 1, wherein during step (ii) P graphs each representative of the oriented links between said nodes and values Vjj′i associated with one of the P operating states.

3. A method according to claim 1, wherein said nodes provide during step (i) said values Vjj′i by way of messages.

4. A method according to claim 3, wherein said messages are compliant with a chosen link state routing protocol.

5. A method according to claim 4, wherein said link state routing protocol is Open Shortest Path First-Traffic Engineering.

6. A method according to claim 5, wherein said values Vjj′i are integrated into dedicated Type-Length-Value fields of Link State Advertisement messages.

7. A method according to claim 1, wherein, in the event that a request is received to allocate a transmission capacity for a communication that is to pass through an input node of said group and an output node of said group, it is additionally provided to have a step (iii) in which it is determined, based on said operating state table and on traffic engineering information related to the actual use of the available transmission capacities of the oriented links, at least one inter-node path that takes oriented links established between said input and output nodes.

8. A method according to claim 7, whenever during step (iii), every time that an oriented link has an available, usable transmission capacity that is less than said transmission capacity defined within said received allocation request, it is determined whether some of the partially available transmission capacity of that same oriented link can be used as a complement to said available, usable transmission capacity in order to meet that received allocation request, and if it can, that oriented link is retained, whereas if it can't, that oriented link is not retained.

9. A method according to claim 7, wherein whenever during step (iii), every time that an oriented link has an available, usable transmission capacity that is less than said transmission capacity defined within said received allocation request, it is determined whether some of the partially available transmission capacity can be used as a complement to said available, usable transmission capacity to fulfill that received allocation request, and if it can, that oriented link is retained, whereas if it can't, it is determined whether some of the unavailable transmission capacity of that same oriented link may be used as a complement of said available usable transmission capacity in order to fulfill that received allocation request, and if it can, that oriented link is retained, whereas if it can't, that oriented link is retained.

10. A method according to claim 8, wherein whenever during step (iii), in the event that it is determined that part of the partially available transmission capacity and/or part of the unavailable transmission capacity of an oriented link is necessary to complement the available and usable transmission capacity of that oriented link in order to fulfill said received allocation request, a message is addressed to at least one of the two nodes that are concerned by that oriented link, requesting that at least one designated element associated with that oriented link be placed into an up state, which had until then been placed in an idle or inactive state.

11. A method according to claim 7, wherein each inter-node path is determined in step (iii) based on at least one chosen criterion.

12. A method according to claim 11, wherein each criterion is chosen from a group comprising at least one criterion related to the number of oriented links in the path, an energy cost criterion, a location criterion, and a load distribution criterion.

13. A method according to claim 12, wherein at least one of said criteria is adjustable based on the links load rate.

14. A device for managing information related to the operating state of a group of nodes of a communications network, connected to one another by oriented links each associated with a maximum transmission capacity controlled by elements of said nodes that make be placed into a state from among P operating states, chosen from among an up state and a down state and/or at least one intermediate idle state, said device being capable of implementing a method according to one of the preceding claims.

15. A network equipment, capable of forming part of a communications network and of being connected to other nodes of that network by oriented links each associated with a maximum transmission capacity controlled by elements of said nodes that may be placed into a state from among P operating states, chosen from among an up state and a down state and/or at least one intermediate idle state, said network equipment comprising an information management device according to claim 14.
